(19) United States
(12) Patent Application Publication
(10) Pub. No.: US 2026/0358132 A1
(43) Pub. Date: Nov. 12, 2026

(54) SYSTEMS AND METHODS FOR DETERMINING LOCATION DATA

(71) Applicant: NEARBY NEARBY, LLC, Asheboro, NC (US)

(72) Inventor: Rhonda Kowald, Asheboro, NC (US)

(21) Appl. No.: 19/741,725

(22) Filed: Jul. 14, 2026

Related U.S. Application Data
(63) Continuation of application No. 18/453,044, filed on Aug. 21, 2023, now abandoned.
(60) Provisional application No. 63/400,964, filed on Aug. 25, 2022.

(51) Int. Cl. G01C 21/34

(52) U.S. Cl. CPC G01C 21/3484; G01C 21/3476

(57) ABSTRACT

Systems and methods for providing locations of interest. In an embodiment, a system comprises a user device associated with a user; an electronic processor configured to receive, from a user device associated with a user, location data for a point of interest; process the location data and a user profile associated with the user through a locations-of-interest model to determine a plurality of locations of interest from a curated set of locations, wherein each of the locations in the set of locations includes a respective location profile, wherein each of the locations of interest is determined based on a mapping between the respective location profile and the user profile; and provide the locations of interest and each of the respective location profiles to the user device.

### CROSS-REFERENCE TO RELATED APPLICATIONS

This application is a continuation of U.S. Patent Application No. 18/453,044, filed Aug. 21, 2023, which claims priority to U.S. Provisional Patent Application No. 63/400,964, filed Aug. 25, 2022, which are incorporated herein by reference in their entireties.

### FIELD

The present disclosure relates generally to information processing and, more particularly, to a method and a system for providing information regarding locations of interest to users.

### BACKGROUND

Location-based services use geographic data and information to provide various services or information to users. Location based services may be used in a variety of contexts including, but not limited to, real-time tracking of objects, providing enhanced security, weather forecasts, traffic updates, navigation or travel, gaming industry, and the like.

### SUMMARY

Embodiments of the present disclosure are generally directed to systems and methods for providing location-based services to users.

The location-based services have completely revolutionized various sectors, including the travel industry. In the travel industry, the location-based services may be used for commute/route predictions and for finding locations of various places. For example, location-based services may assist in locating various places to visit; determining the best route to those locations; determining the distance of those locations from any particular location; and locating nearby restaurants, accommodations, parks, events, amusement parks, bars, and so on.

Earlier, many people used to avoid traveling because travel planning is a time-consuming process. Nowadays technology has made it easier for people to efficiently plan a trip while saving time. However, in many areas, especially rural areas, it is difficult to find information about places and often the information that can be found lacks important details. Moreover, people often find themselves lost because, for example, an address or entrance information associated with a location is inaccurate.

Additionally, there are various platforms that help people with travel planning. For example, there are many mobile applications, web applications, and websites that a person can search for a place which they want to visit. For example, if a person wants to visit “Yellowstone National Park”, they can easily search on the internet “how to visit Yellowstone National Park”. This search may provide a number of search results guiding the person as to how to travel to “Yellowstone National Park”. The person may utilize location services (e.g., a Global Positioning System (GPS)) of their computing device for traveling to “Yellowstone National Park” from their current location.

However, if the person wants to get information about various places or events which are nearby “Yellowstone National Park” such as accommodations, activities, restaurants, bars, businesses, events, etc., then they have to separately search for them. For example, if the person wants to know about restaurants nearby “Yellowstone National Park,” then they have to separately search for restaurants, and the search may provide a list of a plurality of restaurants. Similarly, if the person wants to know about nearby accommodations/hotels, then they have to separately search for accommodations near “Yellowstone National Park” and the search may provide a list of accommodations near “Yellowstone National Park”. Further, if the person wants to know more information (e.g., distance, route, pricing, and the like) about a particular restaurant near “Yellowstone National Park,” then they have to again search separately for that particular restaurant. The user may finally come up with an itinerary plan after performing a detailed search and analysis. However, this approach of separately searching for various places, events, etc. that are nearby a particular place/location is very time consuming and requires the user to actively perform several searches for various places, events, and the like. Further, this approach usually provides information which may be outdated and unreliable. Furthermore, the approach usually produces a large amount of information that may be of little or no interest to the user.

Accordingly, there exists a need for a solution to at least some of the aforementioned problems. For instance, there is an established need for a solution that allows efficient ways to determine locations of interest while saving time and improving user experience. Specifically, there exists a need for a platform that can provide information about nearby locations and desired destinations of travel, such as information about nearby places, events, activities, etc., on a single webpage and with a single search.

In one aspect, disclosed herein, are systems for providing locations of interest comprising. These systems include a user device associated with a user and an electronic processor. The electronic processor is configured to receive, from a user device associated with a user, location data for a point of interest; process the location data and a user profile associated with the user through a locations-of-interest model to determine a plurality of locations of interest from a curated set of locations, wherein each of the locations in the set of locations includes a respective location profile, wherein each of the locations of interest is determined based on a mapping between the respective location profile and the user profile; and provide the locations of interest and each of the respective location profiles to the user device.

In another aspect, disclosed herein, are methods for determining locations of interest. The methods are executed by a processor and include: receiving, from a user device associated with a user, location data for a point of interest; processing the location data and a user profile associated with the user through a locations-of-interest model to determine a plurality of locations of interest from a curated set of locations, wherein each of the locations in the set of locations includes a respective location profile, wherein each of the locations of interest is determined based on a mapping between the respective location profile and the user profile; and providing the locations of interest and each of the respective location profiles to the user device.

In another aspect, disclosed herein, are non-transitory computer readable media having stored thereon executable instructions that, when executed by an electronic processor, cause the electronic processor to perform operations. These operations include receiving, from a user device associated with a user, location data for a point of interest; processing the location data and a user profile associated with the user through a locations-of-interest model to determine a plurality of locations of interest from a curated set of locations, wherein each of the locations in the set of locations includes a respective location profile, wherein each of the locations of interest is determined based on a mapping between the respective location profile and the user profile; and providing the locations of interest and each of the respective location profiles to the user device.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIG. 1 depicts an example system that provides location-based services, in accordance with some aspects of the present disclosure;

FIG. 2 depicts an exemplary high level block diagram of the system, in accordance with some aspects of the present disclosure;

FIG. 3 depicts an example screen capture of a display window, associated with a digital platform, as displayed on a display of a user device, in accordance with some aspects of the present disclosure; and

FIGS. 4A and 4B each depict a flowchart of an example method for providing location-based services, in accordance with some aspects of the present disclosure.

Further aspects and advantages of the present disclosure will be readily understood from the following detailed description with reference to the accompanying drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other embodiments. All of the embodiments described below are exemplary embodiments provided to enable persons skilled in the art to make or use the embodiments of the disclosure and are not intended to limit the scope of the disclosure, which is defined by the claims. Further, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In the following description, certain specific details are set forth in order to provide a thorough understanding of various disclosed embodiments. However, one skilled in the relevant art will recognize that embodiments may be practiced without one or more of these specific details, or with other methods, components, materials, and the like. In other instances, wellknown elements associated with methods and systems for providing location-based services have not been shown or described in detail to avoid unnecessarily obscuring descriptions of the embodiments.

Before any embodiments of the disclosure are explained in detail, it is to be understood that the disclosure is not limited in its application to the details of embodiment and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting, and coupling. Further, “connected” and “coupled” are not restricted to physical or mechanical connections or couplings, and can include electrical or hydraulic connections or couplings, whether direct or indirect.

It should be noted that throughout the specification and claims which follow, the terms “at least one” and “one or more” have been used interchangeably. Further, the terms “user” and “person” have been used interchangeably throughout the specification and claims.

The headings and Abstract of the Disclosure provided herein are for convenience only and do not interpret the scope or meaning of the embodiments.

Shown throughout the drawings, the present invention is directed toward a method and system for providing location-based services to users.

### Definitions

Unless otherwise defined, all technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

Unless the context requires otherwise, throughout the specification and claims which follow, the word “comprise” and variations thereof, such as, “comprises” and “comprising” are to be construed in an open, inclusive sense, that is, as “including, but not limited to.” Moreover, the terms “including” and “having” are intended to be inclusive such that there may be additional elements other than the listed elements. The term “exemplary” is not intended to be construed as a superlative example but merely one of many possible examples.

In the context of the present disclosure, the term “real-time” refers to transmitting or processing data without intentional delay given the processing limitations of a system, the time required to accurately obtain data and images, and the rate of change of the data and images.

In the context of the present disclosure, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. The term “approximately” as used herein refers to any values, including both integers and fractional components that are within a variation of up to ± 10% of the value modified by the term “about.” In certain aspects, the term “approximately” refers to a range of values that fall within 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value). Alternatively, “approximately” can mean within 3 or more than 3 standard deviations, per the practice in the art. Alternatively, such as with respect to biological systems or processes, the term “about” can mean within an order of magnitude, in some embodiments within 5-fold, and in some embodiments within 2-fold, of a value.

In the context of the present disclosure, the term “itinerary planning” should be read in its broadest sense. Itinerary planning refers to a detailed plan for a journey including a list of places to visit, a route to follow, a schedule of events and/or activities related to the list of places, means of transportation, means of accommodation, places/events/activities near to the list of places, and the like.

In the context of the present disclosure, the term “website” should be read in its broadest sense. A website is a central location that includes multiple web pages that are maintained by a person or organization and is accessible to anyone, anywhere at any time using the internet. Websites may contain images, text, audio, video, etc. and may provide visual and textual content that users can view and read. To view a website, one requires a web browser that is an application that is used to browse the internet.

In the context of the present disclosure, the term “location-based services” should be read in its broadest sense. The location-based services may be defined as the technology which uses geographic data and information to provide various services or information to users. The location-based services are provided with the help of various navigation systems such as Global Positioning System (GPS), Wi-Fi, cellular technology, Radio Frequency Identification (RFID), etc. GPS is the most popular navigation system.

In the context of the present disclosure, the term “point of interest” should be read in its broadest sense. The point of interest may include the location of a user as determined by their device(s); a user provided location/address, such as a private domicile, park, trail, business, and the like; or a location associated with an event or activity, such as a community sponsored race, concert, party, and the like.

In the context of the present disclosure, the term “user profile” should be read in its broadest sense. The user profile may be defined as a registered account that includes settings and attributes associated with the respective user account. Example user attributes include one or more itineraries and one or more lists of flagged (e.g., liked) locations, such as, businesses, parks, trails, events, activities, youth activities and the like. In some examples, users can save flagged locations to a private profile that is not shared with other system users. In some embodiments, a user profile includes default search settings. For example, a user may specify an activity type (e.g., indoor, outdoor, hiking, racing, running, and the like), kid friendly, age restrictions, pet friendly, distance threshold, locally owned, and preferred business category (e.g., winery, art studio, brewery). In some embodiments, a user profile includes demographic information for the user or user’s family (e.g., age, number of children, age of children, disabled, and the like). In some embodiments, a user may select a default profile setting from a list of pre-populated templates (e.g., the grandkids are coming over, girl’s night out, kid free weekend). In some cases, a user’s profile includes business related information to allow for business/location owners to manage certain information related to the businesses. In some embodiments, the system uses a default user profile if the user is, for example, anonymous or new.

In the context of the present disclosure, the term “location profile” should be read in its broadest sense. The location profile may be defined as information associated with a particular location registered in the system. A location profile generally includes a number of location attributes. Location attributes include, for example, images, videos, address, map and direction information, geographical information, a location type, contact information (e.g., phone number, office or ranger station location, and the like), a location category (e.g., event, business, activity, parks, trails, and the like), age related information (e.g., adult only 18+, family friendly, golden generation age 55+, pre K, school age, teens, youth only - parent drop off, and the like), pet related information (e.g., allowed, any well behaved pet, cats allowed, clean-up stations, dogs allowed, fenced in area, kennels available, leash required, off leash, available water source, and the like), accessibility (e.g., wheelchair accessible), ideal for (e.g., 18+, 21+, all ages, budget friendly, date night/romance, eco-friendly, family, the kids, girls’ night, golden years - age 55+, group of friends, guys night, large groups, LGBTQ+ friendly, local artists, luxury, me time, night owls, pet friendly, and the like), event data (e.g., in-person event, online event, cost, date, time, description, ideal audience, official links, registration and ticket information, and the like), facility information (e.g., opening and closing times, number and location of bathrooms, food and drinks availability or allowed, payment options, parking locations, shuttle service provided, parking fees, natural features, and the like), additional services (e.g., tours available), information related to food service (e.g., type(s) of food and drink served, locally sourced ingredients, and the like), things to do, outdoor types, tips and tricks, and the like.

In the context of the present disclosure, the term “verification application” should be read in its broadest sense. The verification application may be defined as an application, executed on a user device, that is restricted for use by users with a particular status (e.g., verification status) and provides authenticated users with the ability to verify and authenticate the location data submitted by other users. As a result, in one example, the appearance of a verified badge displayed on listings pertaining to businesses, parks, trails, activities, events, and the like serves the purpose of ensuring that users of the website can ascertain the accuracy and reliability of the information they are presented.

In the context of the present disclosure, the term “curated set of locations” should be read in its broadest sense. The curated set of locations may be defined as businesses, parks, trails, events, activities, and similar entities about which location information is curated into a location profile for each location. In some cases, a portion of the information included in a location profile is verified with a verification application. In some examples, the system provides a user with a number of locations of interest, from the curated set of locations, based on the output of a model that is provided with specified location data and the user’s profile.

In the context of the present disclosure, a mapping between a location profile and the user profile includes matching location data with the user profile and weights assigned to the matched data based on the types of user data and according to the trained AI model.

### Overview

Described herein are systems and methods for providing location-based services to users. As described above, conventionally there are various platforms (e.g., mobile applications, web applications, websites) which provide locations of interest to assist, for example, with itinerary planning. For example, there are various platforms using which a person can search and know about a particular place which they want to visit; there are different platforms which can help the person in booking travel tickets and accommodations; there are different platforms which can help the person in navigating from their current location to the particular place, and the like. In other words, there are various platforms for various types of tasks and a user has to visit a specific type of platform for performing a specific type of task. Generally, itinerary planning involves a plurality of tasks (e.g., route planning, accommodation planning, events/activities planning, nearby locations searching, booking tickets, etc.).

Conventionally, a user has to visit multiple platforms (for example, multiple websites) for itinerary planning. Consider an example where a user wants to visit “Yellowstone National Park”. The user has to open a web page on a web browser to find the distance and route of “Yellowstone National Park” from their current location. If the user wants to get information about various activities or events which are available at “Yellowstone National Park” (e.g., accommodations, activities, restaurants, etc.), then they have to open another web page and search for activities available at “Yellowstone National Park”. Similarly, if the user wants to check restaurants near “Yellowstone National Park”, then they have to open yet another web page and search for restaurants near “Yellowstone National Park”. In this manner, after performing a plurality of searches and analysis on a plurality of web pages, the user may finally come up with an itinerary.

However, this process of itinerary planning is time consuming. Further, searching for a particular task on the internet gives a large amount of information that may be of little interest to the user thereby making it difficult for the user to find the relevant information. Hence, the conventional approaches of itinerary planning are time consuming, non-user friendly and degrade the user experience. Accordingly, there is a need for a system that allows efficient travel planning in a user-friendly manner to save time and improve the user experience.

The present invention overcomes the above-mentioned and various other problems by providing a digital platform (e.g., online platform) that can provide information about everything and anything related to a desired location of travel and information about nearby places, events, activities, accommodations, etc. in a single go (single click). The digital platform may be implemented by a mobile application, or a web application hosted by a server.

### Example System

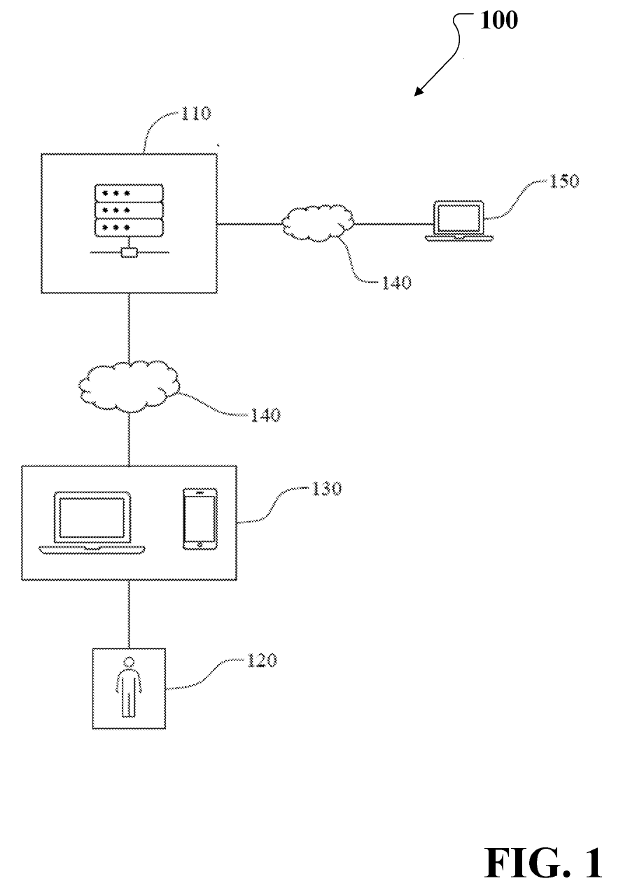

FIG. 1 depicts an example location providing system 100 in accordance with some embodiments of the present disclosure. As can be seen from FIG. 1, the location providing system 100 comprises a server 110 communicatively coupled with a plurality of user devices 130, which may be associated with a plurality of users 120, via a network 140. The server 110 may be further communicatively coupled to an admin device 150 via the network 140. It may be noted that for the sake of brevity only one user and two user devices have been shown in FIG. 1. However, the present disclosure is not limited thereto and generally there can be a plurality of different users each having one or more user devices. Similarly, there can be a plurality of admin devices 150 associated with the administrator. In one aspect, the server 110, user device 130, and admin device 150 may be present in distinct remote locations. In another aspect, the admin device 150 may not be required and all functions of the device 150 may be directly performed using the server 110 (e.g., when the server 110 is located at the premises of the administrator).

In one non-limiting embodiment, devices 130, 150 may be any electronic device having browsing capability. The devices 130, 150 may comprise, but are not limited to, a desktop computer, a laptop computer, a tablet, a mobile computing device (e.g., a cellular telephone, smart telephone, a personal digital assistant, a portable media player, etc.) or the like. However, the present disclosure is not limited thereto and the devices 130, 150 may be any computing device having browsing capability, location service, and/or internet connection.

In some examples, the network 140 may include a wireless network, such as, but not limited to, a cellular network and may employ various technologies including Enhanced Data rates for Global Evolution (EDGE), General Packet Radio Service (GPRS), Global System for Mobile Communications (GSM), Internet Protocol Multimedia Subsystem (IMS), Universal Mobile Telecommunications System (UMTS), High Speed Packet Access (HSPA), Long Term Evolution (LTE), etc. In some examples, the network 140 may include or otherwise cover networks or subnetworks, each of which may include a wireless data pathway.

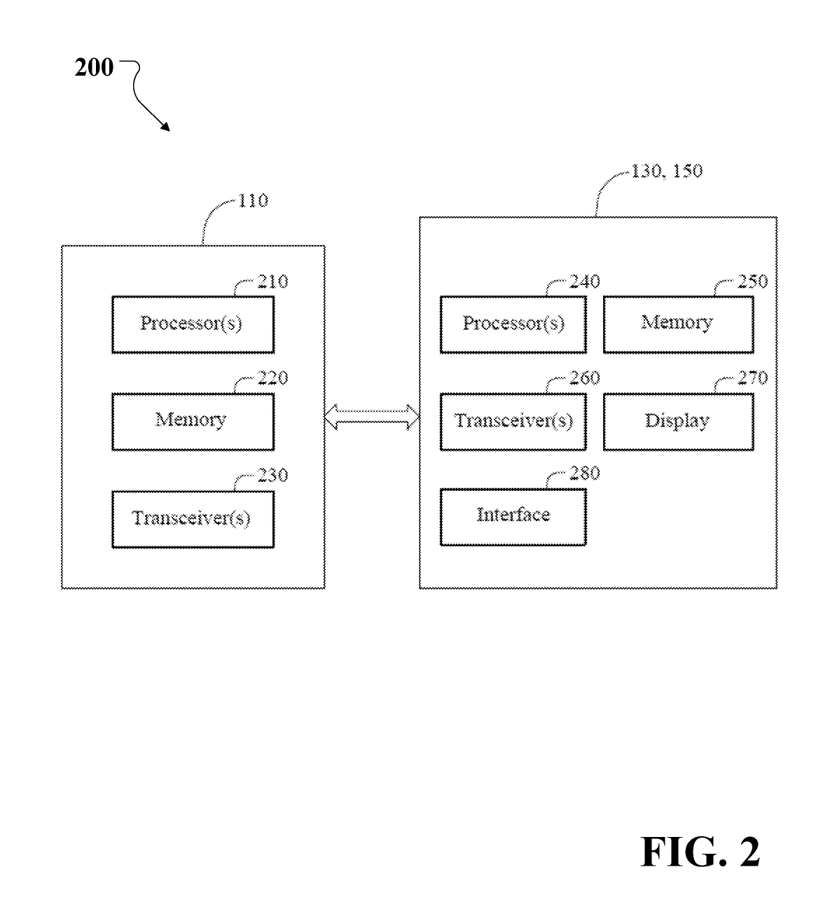

FIG. 2 depicts a block diagram 200 depicting various components of the location providing system 100 of FIG. 1, in accordance with some embodiments of the present disclosure. According to an embodiment of the present disclosure, the location providing system 100 mainly comprises the server 110 and the devices 130, 150. The server 110 may comprise at least one processor 210, at least one memory 220, and at least one transceiver 230. Each of the devices 130, 150 may also comprise at least one processor 240, at least one memory 250, at least one transceiver 260, at least one display 270, at least one interface 280, etc. The server 110 and the devices 130, 150 may communicate with each other using the network 140. The server 110 and/or the devices 130, 150 may further comprise various other components/units/modules which have not been shown (for the sake of brevity) in FIG. 2 including antennas, cameras, microphones, speakers, etc.

The transceivers 230, 260 may be configured to transmit data/information to other computing devices and receive data/information from the computing devices using antennas and interfaces. For example, the transceiver 230 may transmit data/information to the devices 130, 150 and receive data/information from the devices 130, 150. Similarly, the transceiver 260 may transmit data/information to the server 110 and receive data/information from the server 110. The processor 210 may be configured to control the operations of various units/components of the server 110. The processor 210 is communicatively coupled with the transceiver 230 and the memory 220. Similarly, the processors 240, communicatively coupled with the memory 250, the transceiver 260, the display 270, and the interface 280, may be configured to control the operations of various units/components of the devices 130, 150.

The processors 210, 240 may include a general-purpose processor, a Field Programmable Gate Array (FPGA), an Application Specific Integrated Circuit (ASIC), a Digital Signal Processor (DSP), microprocessors, microcomputers, micro-controllers, digital signal processors, central processing units, state machines, logic circuitries, and/or any devices that manipulate signals based on operational instructions. The interface 280 may include a variety of software and hardware interfaces, for example, a web interface, a graphical user interface, an input device-output device (I/O) interface, an access network interface, and the like. The I/O interface may allow the devices 130, 150 to interact with the server 110 directly or through other devices. The network interface may allow the devices 130, 150 to interact with the server via the network 140.

The processors 210, 240 are in communication with respective memories 220, 250. Memories 220, 250 may include one or more volatile or non-volatile data storage devices or may represent a data storage function of a device. For example, memory 220, 250 may include a nonvolatile data storage device for storing programmed instructions or data for operation of the server 110 and devices 130, 150 in accordance with some embodiments of the present invention. Memory 220, 250 may be used to store data that is generated during communication between the server 110 and the devices 130, 150.

Memory 220, 250 may include a non-transitory machine-readable storage medium that may be any electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, a storage drive, an optical disc, or the like. The machine-readable storage medium may be encoded with executable instructions.

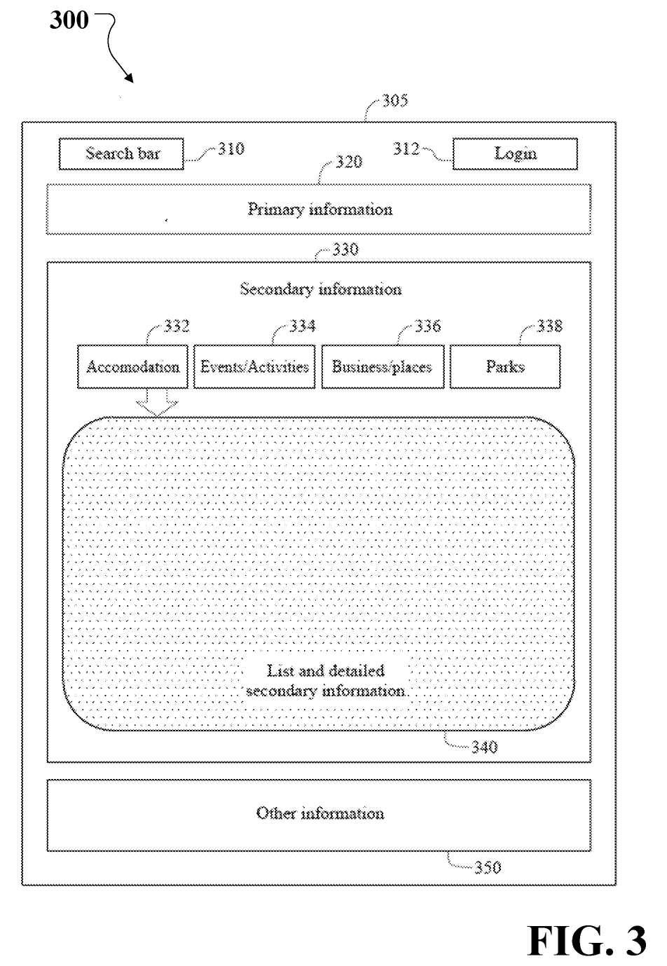

In one non-limiting embodiment, the server 110 hosts and/or controls a website, a web application, or a mobile application (hereinafter referred to as “digital platform”) which provides various types of information related to different travel locations such as information about nearby places, events, excursions, activities, accommodations, etc., as shown in the exemplary illustration of FIG. 3. This single digital platform can provide details about various locations for itinerary planning including route planning, accommodation planning, events/activities planning, nearby locations, searching, ticket booking, but not limited thereto. The digital platform is administered by an administrator using the admin device 150. Forthcoming paragraphs now describe the detailed process explaining how the described location providing system helps the users in itinerary planning.

In some embodiments, the server 110 hosts and/or controls the training of and processing data through an AI model. Once trained, in some embodiments, a locations-of-interest model is employed to determine a plurality of locations of interest from a curated set of locations by processing the location data or a user profile associated with a user. In one example, a locations-of-interest model is trained using labels from, for example, a supervised method with hand-labeled methods (e.g., where a user assigns previously received location data or user profile data the desired labels) or supervised learning using automatic labeling methods with other sensors (e.g., imaging devices such as cameras, Global Positioning System (GPS) sensors, or other information received from user devices such as data related to a location). In some embodiments, the machine-learning computational model is trained using unsupervised/self-supervised methods by learning, for example, how to determine relevant location information related to a particular user profile or location data provided by a user device. In some embodiments, a mixture of one or more of the above-described training methods is employed. For example, an unsupervised method can be employed to learn the network weights and a supervised method to fine tune the network, along with human-labeled data to capture challenging corner cases.

### Example User-Interface

FIG. 3 depicts an example screen capture 300 of a display window 305 (e.g., associated with the digital platform-mobile app, webpage, web app) shown on the display 270 of the user device 130, in accordance with some embodiments of the present disclosure. As shown in FIG. 3, the display window 305 may comprise a number of areas/regions/sub-windows including headers, navigation bars, content areas, sidebars, footers, etc. Particularly, the display window 305 may include a search bar 310, a login input field 312, a region (sub-window) 320 for displaying primary information corresponding to a particular location, a region (sub-window) for displaying secondary information 330, and various other regions for displaying additional information 350 corresponding to the particular location. The region for displaying secondary information 330 may include various sub-regions having selectable input fields corresponding to accommodations, events/activities, business/places, parks, but not limited thereto. The display window may further comprise a region (e.g., sub-window) 340 for displaying a list and detailed information corresponding to the selected input field. The regions for displaying additional information 350 may include various buttons/windows including “About us”, “Terms and conditions”, “contact us”, “FAQs”, “request listing”, but not limited thereto.

In one non-limiting embodiment, when a user is planning to go to a particular desired location or place, they may perform a search using a digital platform for that particular desired location. For example, if the user is planning to visit “Yellowstone National Park” then they may perform a web search, for example, ‘how to go to Yellowstone National Park’. The search engine may give a plurality of search results; and the user may open a link to the digital platform and then access the digital platform from the search results. In another non-limiting embodiment, when the digital platform is a website, the user may directly open the website in a web browser and may type the name of the desired location (e.g., ‘Yellowstone National Park’) in the search bar 310 provided on the website. Similarly, when the digital platform is a mobile application, the user may directly open the mobile application (“app”) in a computing device associated with the user and may type the name of the desired location e.g., “Yellowstone National Park” in the search bar 310 provided in the mobile application (“app”). In some embodiments, a map is provided displaying the primary point of interest with a specific color marker with other locations of interest, as determined by the described system, displayed around the primary point.

In one non-limiting embodiment, the platform may support auto-suggestion and auto correction features. For example, when the user starts typing the name of the desired location in the search bar 310, the platform may provide a list of options related to what the user has typed. The list keeps on dynamically changing as the user keeps on typing. Further, if the user has typed anything wrong (e.g., a wrong name of the destination) then the digital platform may auto-suggest correct names related to the words typed by the user.

In the context of the digital platform, the “location” may be indicative of anything with a physical or virtual address including events, places, hotels, activity/event sites, geographical locations, businesses, parks, trails, attractions, camps, schools, workshops, classes, or the like.

When the user inputs the desired location on the digital platform, they may be presented with the primary information related to the desired location in the sub-window 320 of the display window 305. The primary information may be retrieved from the memory 220 of the server 110. For example, the digital platform may provide primary information in the form of details regarding the geographical data (e.g., location coordinates) of the desired location, type of the desired location (e.g., whether the desired location is a hill station, a museum, a park, etc.), events/activities at the desired location, historical background, images/videos of the desired location, tips and tricks provided by travelers, opening/closing timings, facilities provided, map and direction, contact information, or the like. The user may get the complete understanding of the desired location, for example what they can do at the desired location, by going through the information presented in the sub-window 320. It may be noted here that all this information about the desired location is manually entered and continuously updated by an administrator after proper research and verification. For instance, the administrator may enter various types of information using the admin device 150 and the information may be stored in the memory 220 of the server 110. Hence, the digital platform provides the users with correct and accurate information about the desired location and prevents them from being misguided.

In addition to providing the primary information corresponding to the desired location, the digital platform of the present disclosure also provides hierarchical information related to several anticipated next searches (also referred to as “the next step information” or “secondary information” in some portions of the present disclosure) automatically on the same display window of the digital platform. In other words, the server 110 enables the digital platform to automatically provide various types of information associated with the desired location, such as, but not limited to, nearby places, events, excursions, activities, accommodations, museums, libraries, bars, clubs, pubs, etc. It may be noted here that the secondary information is automatically provided to the user on the display window on which the primary information about the desired location is provided. Hence, the user does not need to perform additional searches to obtain the secondary information.

Referring back to the above example, where the user intends to visit the “Yellowstone National Park,” the user is provided with various types of information related to the Yellowstone National Park including its geographical location, distance from the user’s current location, best possible route in terms of distance and traffic, events which are organized at Yellowstone National Park, opening/closing timings, historical background of Yellowstone National Park, photos/videos, tips and tricks provided by other users, contact information, etc. Consider that Yellowstone National Park is far from the user’s residence and the user is interested in attending a late-night party organized at the Yellowstone National Park. Since it would be difficult for the user to come back to his residence after the party, the user may decide to stay near the Yellowstone National Park.

The conventional solutions would require the user to carry out a separate search for ‘accommodations near the Yellowstone National Park’. However, in the digital platform of the proposed disclosure, the user can simply scroll down the listing page of the Yellowstone National Park and click on the accommodations button 332 presented on the display window 305. With a simple click of the accommodations button 332, the user is provided with a list of all nearby lodging options (e.g., hotels) available and their distance from the Yellowstone National Park. The list and related information may be displayed in the sub-window 340 of the same page associated with the Yellowstone National Park. The user can browse the listings and find a suitable lodging location based on their comfort and interest. The user may be provided with an option of online booking and/or to contact the lodging location. Since each lodging location is manually vetted and entered by the administrator, the chances of a user finding something of value are comparatively higher. The listings may be ordered based on distance from the desired location (e.g., Yellowstone National Park), ratings provided by users, past travel history of the user, and the like. For example, the lodging locations with higher user ratings may be listed on top of the list. Similarly, if a user is frequently visiting a lodging location of a particular type/brand, the same can be listed on top.

The user may then decide to explore various events/activities near their lodging location. The user may simply click on the ‘events/activities’ tab/button 334 without leaving the same display window associated with the Yellowstone National Park. The user may be shown a list of all nearby events/activities along with their distance from the lodging location (e.g., determined, via a trained AI model, based on provided location data for a point of interest and their user profile). The user may select any event/activity based on their interest. Consider that the user decides to go trekking from the lodging location. The user may then decide that maybe they should collect some sandwiches from a local grocery store before going trekking. The user may simply click on the ‘business/places’ button 336 without leaving the same page associated with the Yellowstone National Park. The user may be shown a list of all nearby businesses (e.g., grocery stores) along with their distance from the lodging location. Now, the user may check on the same display window whether there is any event happening at the trekking location that they might be interested in. In this manner, the user keeps on exploring the next step information without opening separate windows/pages. Similarly, the user is enabled to search for nearby parks and trails by selecting input field “Parks” 338, and the results are shown in the same display window.

It is contemplated that various other input fields corresponding to other nearby features of the particular location may be displayed in the sub-window 320 for the user to select and access all possible information about the particular location in the same display window.

It is further contemplated that the digital platform may further comprise an option for the user to specify a “date” as an alternative to or in addition to the “location”. Based on the user input in the date option, the digital platform may display information related to the specified date and/or location in the display window 305. The information may comprise information related to events happening nearby to the user, or near to the desired location on or around the specified date.

In one non-limiting embodiment, the users may be provided an option of logging into the digital platform using a login window. Initially, the users may be required to register on the digital platform and post successful registration, they may be provided login credentials (e.g., unique login identity and password). The user may login to the digital platform and while they are looking for and finding places, they can save each location to their private profile and make a list or itinerary plan. The user may be provided with an option of saving this itinerary plan and sharing the itinerary plan on social media and with their friends/other users. The user may share their itinerary plan with a community forum on the digital platform. In one nonlimiting embodiment, the present disclosure may also provide an option of having conversations linked to each individual listing (e.g., allowing conversations and questions to be asked/answered on individual listings).

In one non-limiting embodiment, the present disclosure provides an option of franchising the digital platform and business structure to external parties where a person/party pays a monthly/yearly fee for a franchised location which could be state based, city based, county based, suburb, niche based, etc. In one non-limiting embodiment, the addition of various locations and/or businesses (e.g., places, events, excursions, activities, accommodations, museums, libraries, bars) is done by the administrator on request from the business owners. For example, a hotel owner may contact the administrator for listing their hotel on the digital platform. The administrator, upon successful verification of the request, may list the hotel on the digital platform. In one aspect, the users and/or business owners may be provided with an option of submitting a request for listing of various locations and/or businesses. The administrator, upon successful verification of the requests, may list the locations and/or businesses on the digital platform.

It may be noted here that all the data saved in the memory 220 is inter-connected. If a user is looking for a specific location, they can easily find out what parks, businesses, attractions, events, etc. are located either at that specific location or near to it. Also, the user can easily find out how far away the parks, businesses, attractions, events, etc. are from the specific location. It is important to note here that all this is done without having to leave a single listings page and start new searches.

In this manner, the techniques of the present disclosure simplify the process of determining locations of interest and save the time consumed in finding relevant and useful locations and information for the user. The digital platform of the present disclosure connects the community as a whole and allows the users visiting an area or location with the ability to find things that they are needing near that location with a simple scroll down on the location’s listing page. The entire concept around the innovative concept is the forethought of what someone would want to know or maybe even learn about what’s available around a location without having to have an entirely new search.

### Example in Operation

A user accesses the digital platform (e.g., a website or a mobile application) with the help of a user device 130 having internet connectivity. However, the present disclosure is not limited thereto, and the invention may work even without internet connection. For example, the user may download the data on their user device 130 and then perform itinerary planning using the downloaded data (without needing the internet connectivity).

The memory 220 of the server 110 stores information that is centralized around specific points of interest e.g., city, state, zip code, etc. The information in the memory is obtained from internal information sources, such as user generated or added by the administrator company.

A user visits the digital platform when they want information about a specific location or when they are looking for things to do around/near to a specific location. The user may perform a search for the specific location or select a category of interest from a plurality of categories displayed on the display 270. When the user selects a category, they may be shown an accompanying map showing multiple locations of that category on the map with pinpoints. The user may select a particular location from the multiple locations about which they are interested.

The selection of the particular location may take the user to the location’s individual listing page. The location’s individual listing page may provide primary information of the particular location. Additionally, the location’s individual listing page may also provide the next step information or secondary information without the user needing to make an entirely new search for the next step information. The next step information or secondary information provides nearby information related to the particular location including nearby places, events, excursions, activities, accommodations, museums, libraries, bars, etc. The user may browse through the next step information and save the locations/events/activities of their interest to a private profile.

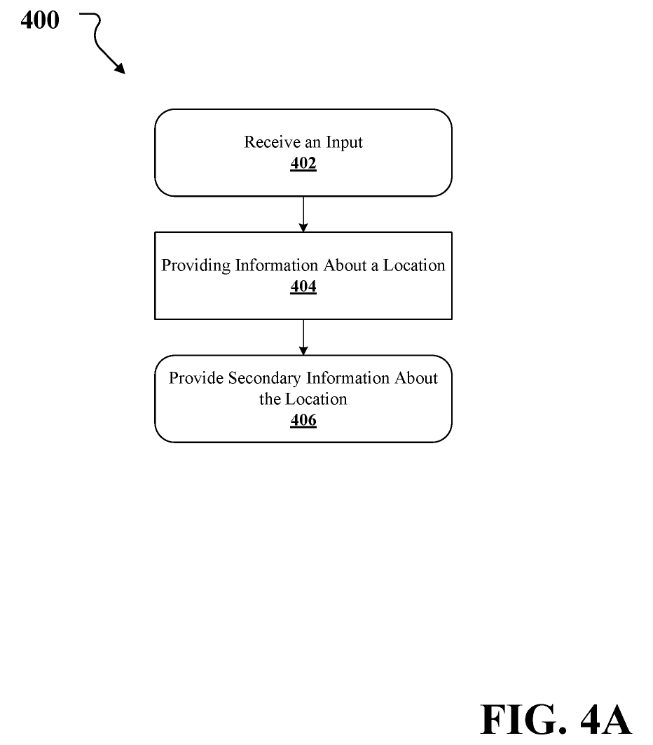

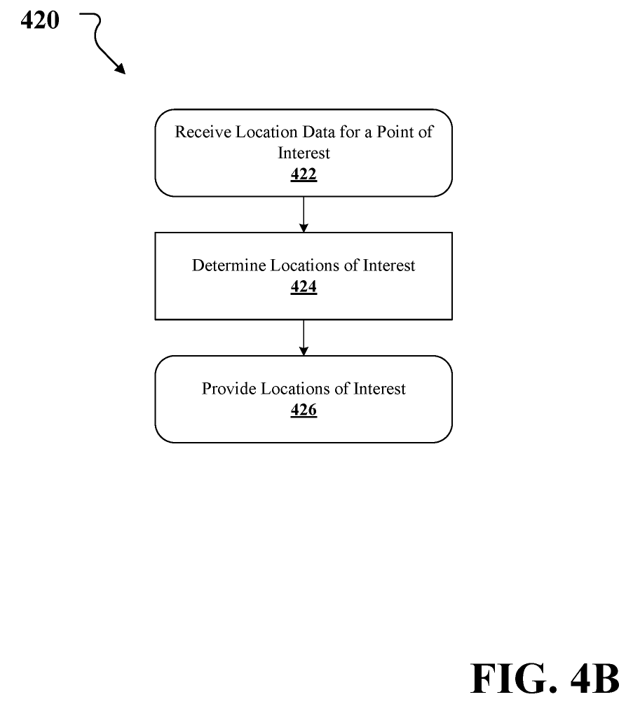

FIGS. 4A and 4B each depict a flowchart showing an example method 400 and 420 respectively for providing location-based services to a user, according to an embodiment of the present disclosure. The methods 400 and 420 are merely provided for exemplary purposes, and embodiments are intended to include or otherwise cover any methods or procedures for providing location-based services.

As depicted, the method 400 includes, at block 402, receiving, by a server 110 from a user device 130, an input from a user 120. The input being indicative of a particular location (e.g., user desired location of travel). The input is received via a digital platform hosted by the server 110 and accessed by the user on the user device 130. For example, the at least one processor 210 of server 110 of FIG. 2 in conjunction with the transceiver 230 may be configured to receive the input from the user device. From block 402, the method 400 proceeds to block 404.

The method may include, at block 404, based on the received input, providing, by the server 110 to the user device 130, primary information associated with the particular location. The providing of primary information comprises displaying primary information in a display window of the digital platform. For example, the at least one processor 210 of server 110 of FIG. 2 may be configured to provide the primary information pertaining to the particular location.

In one non-limiting embodiment, the primary information pertaining to the particular location may comprise one or more of: geographical data corresponding to the particular location, events and activities happening at the particular location, images and videos of the particular location, opening and closing timings associated with the particular location, map and direction information associated with the particular location, and contact information associated with the particular location, but not limited thereto. From block 404, the method 400 proceeds to block 406.

At block 406, the method 400 includes further providing, by the server 110 to the user device 130, secondary information associated with the particular location, wherein further providing comprises displaying secondary information in the same display window that displays the primary information. For example, the processor 210 of server 110 of FIG. 2 may be configured to automatically provide the secondary information along with the primary information pertaining to the desired location. It may be noted that the primary information and the secondary information pertaining to the desired location are displayed on the same display window (e.g., webpage, mobile app page) associated with the digital platform hosted by the server. From block 406, the method 400 ends.

In one non-limiting embodiment, the secondary information comprises nearby information associated with the desired location including one or more of: nearby places, events, excursions, activities, businesses, accommodations, museums, libraries, bars, trails, or parks but not limited thereto.

As depicted, the method 420 includes, at block 422, receiving, from a user device 130 associated with a user 120, location data for a point of interest. For example, the location data may be received by a process executed at least one processor 210 of server 110 of FIG. 2. In some embodiments, the point of interest is the location of the user device. In some embodiments, the point of interest is at a location other than the location of the user device. From block 422, the method 420 proceeds to block 424.

At block 424, the location data and a user profile associated with the user are processed through a locations-of-interest model to determine a plurality of locations of interest from a curated set of locations. In some embodiments, each of the locations in the set of locations includes a respective location profile. In some embodiments, each of the locations of interest is determined based on a mapping between the respective location profile and the user profile. In some embodiments, location data associated with the respective location is received for each of the locations in the curated set of locations. In some embodiments, a verification of the respective location data is received, from a verification user device, for each of the locations in the curated set of locations. In some embodiments, each location profile is amended with the respective, verified location data.

In some embodiments, the user profile includes a plurality of user attributes, and wherein each location profile includes a plurality of location attributes. In some embodiments, the user attributes include at least one of an itinerary, flagged locations, default search settings, and demographic information. In some embodiments, the location attributes include at least one of images, videos, address, map and direction information, geographical information, a location type, contact information, location category, age related information, pet related information, ideal for, event data, facility information, additional services, information related to food service, things to do, outdoor types, and tips and tricks. In some embodiments, the user attributes include a threshold distance, and wherein each of the locations of interest is within the threshold distance from the point of interest. In some embodiments, the threshold distance is set to a default distance or a threshold attribute in the user profile. In some embodiments, the locations-of-interest model assigns a weight to a relationship between each of the user attributes and each of the location attributes based on the mapping between the location profiles and the user profile.

In some embodiments, the locations-of-interest model comprises a trained AI model. In some embodiments, the locations-of-interest model is trained with a plurality of user profiles associated with other users and the curated set of locations. In some embodiments, the locations-of-interest model is trained using supervised learning. In some embodiments, the locations-of-interest model comprises a trained neural network. From block 424, the method 420 proceeds to block 426.

At block 426, the locations of interest and each of the respective location profiles are provided to the user device 130. From block 426, the method 420 ends.

It may be noted here that the subject matter of some or all embodiments described with reference to FIGS. 1-3 may be relevant for the methods and the same is not repeated for the sake of brevity.

### Example Scenarios

Sally is visiting her parents. She goes to the platform’s website/application and enters her parents’ address on the search bar. This is the first time the residential address has been entered into the system so no pre-populated information is associated with the address in the database (like for example a business listing would have). The address is shown, via the application, as the primary point of interest on the search results page. A pre-populated map is displayed with the primary point of interest in one color (e.g., purple) and other locations/activities determined according to Sally’s user profile within a threshold distance. Because Sally wants to find kidfriendly activities, she selects the youth activities tab and only those locations/activities that are marked as activities for kids are displayed. Sally then narrows down the list further via the site settings or a specific profile setting that she has already set up within her profile. Sally may also narrow down the list by date since she knows that her kids are only visiting for the week and she does not need to know about the fall festival event next month.

Bill just got out of the concert with his dog Max. He uses his device to find his current location or pulls up the concert from a list of events in the area. The concert venue information is displayed along with nearby next step locations determined according to Bill’s user profile. The Venue/Event is showcased on the map with a specific colored map marker along with the determined locations. Bill selects pet friendly and the displayed locations are narrowed accordingly (e.g., the businesses, parks, trails, events, and activities that are pet friendly are displayed in the map). Bill is inspired to do something new and finds a fenced-in dog park where Max can play.

John reviews the application for upcoming events in the city. He finds a concert that is pet friendly where dogs are allowed on a leash. Without leaving the concert details page, John simply scrolls down the page to the nearby restaurant section and enters additional search criteria for dog friendly and large groups. Restaurants fitting these criteria (as well as John’s user profile setting) that are within a threshold distance from the concert venue are displayed on the map (and in a list under the map with additional details). John shares the locations with his friends for help deciding where to make reservations. John also decides that he wants to head down early to take his dog for a walk. He simply clicks over to the park tab where all the parks are listed as curated based on John’s profile (e.g., dog friendly parks). John narrows the list (e.g., by updating his profile or selecting new criteria) and selects the perfect park for his dog and him to visit before dinner.

### Non-transitory Computer Readable Storage Medium

In some embodiments, the platforms, systems, media, and methods disclosed herein include one or more non-transitory computer readable storage media encoded with a program including instructions executable by the operating system of an optionally networked computer. In further embodiments, a computer readable storage medium is a tangible component of a computer. In still further embodiments, a computer readable storage medium is optionally removable from a computer. In some embodiments, a computer readable storage medium includes, by way of non-limiting examples, compact disc read-only memories (CD-ROMs), digital versatile discs (DVDs), flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the central processing units (CPU) of the computer, written to perform a specified task. Computer readable instructions may be implemented as program modules, such as functions, objects, application programming interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Machine Learning

In some embodiments, machine learning algorithms are employed to build a locations-of-interest model to determine locations of interest. Examples of machine learning algorithms may include a support vector machine (SVM), a naïve Bayes classification, a random forest, a neural network, deep learning, or other supervised learning algorithm or unsupervised learning algorithm for classification and regression. The machine learning algorithms may be trained using one or more training datasets. For example, previously received location or user data may be employed to train various algorithms. Moreover, as described above, these algorithms can be continuously trained/retrained using real-time user data as it is received. In some embodiments, the machine learning algorithm employs regression modeling where relationships between variables are determined and weighted. In some embodiments, the machine learning algorithm employs regression modeling, wherein relationships between predictor variables and dependent variables are determined and weighted.

### Web Application

In some embodiments, a computer program includes a web application. A web application refers to an application software that runs on a web server, unlike computer-based software programs that are run locally on the operating system of the device. The web application is accessed by a user through a web browser with an active network connection. A part of the web application may run on a remote server and another part may run on a client device usually inside a web browser and both parts may communicate over a computer network, for example the internet. In some embodiments, a web application is created using a software framework such as Microsoft® .NET or Ruby on Rails (RoR). In some embodiments, a web application employs one or more database systems including, by way of non-limiting examples, relational, non-relational, object oriented, associative, and eXtensible Markup Language (XML) database systems. In further embodiments, suitable relational database systems include, by way of non-limiting examples, Microsoft® SQL Server, mySQL™, and Oracle®. A web application may be written in one or more markup languages, presentation definition languages, client-side scripting languages, serverside coding languages, database query languages, or combinations thereof.

### Mobile Application

In some embodiments, a computer program includes a mobile application provided to a mobile device. In some embodiments, the mobile application is provided to a mobile device at the time it is manufactured. In other embodiments, the mobile application is provided to a mobile computer via the computer network described herein. The mobile applications are often in contrast to desktop applications which are designed to run on desktop computers, and web applications which run in web browsers rather than directly on the mobile device. Many mobile applications require internet access. A mobile application is created by techniques known to those of skill in the art using hardware, languages, and development environments known to the art. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

### Standalone Application

In some embodiments, a computer program includes a standalone application, which is a program that is run as an independent computer process, not an add-on to an existing process, (e.g., not a plug-in). Standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable compiled applications.

### Software Modules

In some embodiments, the systems and methods disclosed herein include software, server, or database modules. Software modules are created using machines, software, and languages. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of nonlimiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Data Stores

In some embodiments, the platforms, systems, media, and methods disclosed herein include one or more data stores. Data stores include repositories for persistently storing and managing collections of data. Types of data store repositories include, for example, databases and simpler store types, or use of the same. Simpler store types include files, emails, and so forth. In some embodiments, a database is a series of bytes that is managed by a DBMS. In various embodiments, suitable databases include, by way of non-limiting examples, relational databases, non-relational databases, object-oriented databases, object databases, entity-relationship model databases, associative databases, and XML databases. Further non-limiting examples include SQL, PostgreSQL, MySQL, Oracle, DB2, and Sybase. In some embodiments, a database is cloud computing based.

In some embodiments, some of the method steps described above may be executed or carried out by a computing system including a tangible computer-readable storage medium, also described herein as a storage machine, that holds machine-readable instructions executable by a logic machine (e.g., a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that a certain task is to be executed by the computing system, such as requesting the computing system to display any of the above described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an API.

Furthermore, the modules, processes, systems, and sections may be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors, or systems described above may be implemented as a programmed general purpose computer, an electronic device programmed with microcode, a hardwired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future (e.g., any elements developed that perform the same function, regardless of structure).

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. §112(f) interpretations as “means-plus-function” language unless specifically expressed as such by use of the words “means for” or “steps for” within the respective claim.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example embodiments does not define or constrain this disclosure. Other changes, substitutions, and alterations are also possible without departing from the spirit and scope of this disclosure.

What is claimed is:

1. A computer-implemented method comprising:
receiving, from a user device associated with a user profile, location data for a point of interest;
selecting, from location profiles corresponding to locations within a threshold distance from the point of interest, one or more candidate location profiles having a value for a location attribute that matches an attribute value identified by a rule stored as part of the user profile;
determining, from the one or more candidate location profiles, a location of interest based on a status indicating that the value for the location attribute of a respective location profile associated with the location of interest was confirmed by at least one user profile authorized to verify the respective location profile;
generating, based on the status, an instruction associated with the respective location profile; and
providing the respective location profile and the instruction to the user device.

2. The computer-implemented method of claim 1, wherein the at least one user profile authorized to verify the respective location profile does not include the user profile associated with the user device.

3. The computer-implemented method of claim 1, wherein the at least one user profile authorized to verify the respective location profile includes a user account associated with an administrator of a digital platform storing the respective location profile.

4. The computer-implemented method of claim 1, wherein the status is assigned to the value for the location attribute in response to receiving, from the at least one user profile authorized to verify the respective location profile, an indication confirming the value for the location attribute.

5. The computer-implemented method of claim 1, wherein determining the location of interest includes applying the rule based on the status assigned to the value for the location attribute of the respective location profile.

6. The computer-implemented method of claim 1, wherein a default search setting of the user profile defines both the threshold distance and the attribute value, and selecting the one or more candidate location profiles includes applying the threshold distance and the attribute value from the default search setting to the location profiles.

7. The computer-implemented method of claim 1, wherein the status further indicates that the confirmation was received within a temporal threshold associated with the rule.

8. The computer-implemented method of claim 7, wherein determining the location of interest includes selecting the respective location profile from the one or more candidate location profiles based on the status indicating that the confirmation for the value for the location attribute of the respective location profile is within the temporal threshold.

9. The computer-implemented method of claim 1, wherein the status indicates that the confirmation is associated with geographic location data corresponding to the at least one user profile authorized to verify the respective location profile.

10. The computer-implemented method of claim 1, further comprising updating the respective location profile to associate the status with the value for the location attribute.

11. The computer-implemented method of claim 10, wherein determining the location of interest includes using the value for the location attribute based on the status associated with the value indicating that the value has been confirmed by the at least one user profile authorized to verify the respective location profile.

12. The computer-implemented method of claim 1, wherein the status indicates that the value for the location attribute has a confirmation from a user profile authorized to verify location profiles.

13. The computer-implemented method of claim 1, wherein the threshold distance is defined by a search setting of the user profile.

14. The computer-implemented method of claim 1, wherein determining the location of interest includes applying the rule to the value for the location attribute based on the status indicating a source priority for the value among a plurality of values for the location attribute from a plurality of sources.

15. The computer-implemented method of claim 14, wherein the source priority prioritizes a value from a source corresponding to a user profile authorized to verify the respective location profile.

16. The computer-implemented method of claim 15, wherein determining the location of interest includes applying the rule to the value from the source corresponding to the user profile authorized to verify the respective location profile.

17. A system comprising:
a user device associated with a user profile; and
an electronic processor configured to:
receive, from a user device associated with a user profile, location data for a point of interest;
select, from location profiles corresponding to locations within a threshold distance from the point of interest, one or more candidate location profiles having a value for a location attribute that matches an attribute value identified by a rule stored as part of the user profile;
determine, from the one or more candidate location profiles, a location of interest based on a status indicating that the value for the location attribute of a respective location profile associated with the location of interest was confirmed by at least one user profile authorized to verify the respective location profile;
generate, based on the status, an instruction associated with the respective location profile; and
provide the respective location profile and the instruction to the user device.

18. The system of claim 17, wherein the at least one user profile authorized to verify the respective location profile does not include the user profile associated with the user device.

19. A non-transitory computer readable medium having stored thereon executable instructions that, when executed by an electronic processor, cause the electronic processor to perform operations comprising:
receiving, from a user device associated with a user profile, location data for a point of interest;
selecting, from location profiles corresponding to locations within a threshold distance from the point of interest, one or more candidate location profiles having a value for a location attribute that matches an attribute value identified by a rule stored as part of the user profile;
determining, from the one or more candidate location profiles, a location of interest based on a status indicating that the value for the location attribute of a respective location profile associated with the location of interest was confirmed by at least one user profile authorized to verify the respective location profile;
generating, based on the status, an instruction associated with the respective location profile; and
providing the respective location profile and the instruction to the user device.

20. The non-transitory computer readable medium of claim 19, wherein determining the location of interest includes applying the rule stored as part of the user profile to the value for the location attribute based on the status indicating confirmation of the value by a verifier profile authorized to verify the location attribute.
